(19) United States
(12) Patent Application Publication
(10) Pub. No.: US 2026/0358853 A1
(43) Pub. Date: Nov. 12, 2026

(54) Independent Optimization of Hardware Compression and Decompression of Data

(71) Applicant: Marvell Asia Pte Ltd., Singapore (SG)

(72) Inventors: Steven C. Barner, Shrewsbury, MA (US); Wilson P. Snyder, II, Holliston, MA (US); Nichlas Mariam, Arlington, MA (US); Dennis Ellert, Bragg Creek (CA); Ilian Tzvetanov, Ottawa (CA); David Fenton, Kanata (CA)

(21) Appl. No.: 19/672,251

(22) Filed: May 8, 2026

Related U.S. Application Data
(60) Provisional application No. 63/803,473, filed on May 9, 2025.

(51) Int. Cl. G06F 1/06

(52) U.S. Cl. CPC G06F 1/06

(57) ABSTRACT

Embodiments disclose a system for optimizing compression and decompression of data. The system includes a compression engine receiving a first clock signal, the first clock signal having a first frequency, the compression engine configured to compress data, the first clock signal being used to regulate a speed of data compression by the compression engine. The system further includes a decompression engine receiving a second clock signal, the second clock signal having a second frequency, the decompression engine configured to decompress data, the second clock signal being used to regulate a speed of data decompression by the decompression engine. In embodiments, the first frequency and the second frequency may be different frequencies, and may be respectively configured to optimize at least one performance metric associated with the compression and decompression of data.

### RELATED APPLICATION

This application claims the benefit of U.S. Provisional Application No. 63/803,473, filed on May 9, 2025. The entire teachings of the above application are incorporated herein by reference.

### BACKGROUND

In the realm of data storage, reducing the size of the data file prior to storage is a common practice that provides for a large amount of data to be stored in a memory. However, this then necessitates the subsequent process of reverting the file back to its original size when it is later called upon to be viewed or utilized. The process of reducing the file size of data is often referred to as data compression, and the process of reverting the file back to its original size is often referred to as data decompression. The speed at which compression and decompression occurs is driven largely by the frequency of a clock associated with the compression and decompression.

### SUMMARY

Embodiments relate toward a system for optimizing compression and decompression of data by utilizing dedicated clocks with respective signals for compression tasks and dedicated clocks with respective signals for decompression tasks, respectively. Such a system may include a compression engine receiving a first clock signal, the first clock signal having a first frequency. The compression engine may be configured to compress data, and the first clock signal may be used to regulate a speed of data compression by the compression engine. Such an embodiment may further include a decompression engine receiving a second clock signal, the second clock signal having a second frequency. The first frequency associated with the first clock signal and the second frequency associated with the second clock signal may be different frequencies (e.g., the first clock signal and the second clock signal may operate at respective speeds). The decompression engine may be configured to decompress data, and the second clock signal may be used to regulate a speed of data decompression by the decompression engine. Further, in such an embodiment, the first frequency and the second frequency may be configured to optimize at least one performance metric associated with the compression and decompression of data.

According to an embodiment, the at least one performance metric includes, for example, latency, power consumption, area, or any combination thereof.

According to another embodiment, the second frequency may be a higher frequency than the first frequency. For example, the respective first clock signal may be configured to optimize compression tasks, and the respective second clock signal may be configured to optimize decompression tasks.

An embodiment may further include a memory configured to receive compressed data from the compression engine and further configured to transmit compressed data to the decompression engine. In such an embodiment, the memory may be a computer express link (CXL) memory expander.

According to an embodiment, the first clock signal may be generated by a first programmable clock configured to generate a first programmed frequency, and the second clock signal may be generated by a second programmable clock configured to generate a second programmed frequency.

In another embodiment, the compression engine may be a given compression engine of a plurality of compression engines. Such an embodiment may also include the first clock signal being coupled to the plurality of compression engines.

In an embodiment, the first clock signal may be a given compression clock signal of a plurality of compression clock signals, and the compression engine may be a given compression engine of a plurality of compression engines. Such an embodiment may also include at least one compression clock signal of the plurality of compression clock signals being coupled to at least one compression engine of the plurality of compression engines. Further, such an embodiment may also include at least one switch configured to control a distribution of each clock signal from each of the plurality of compression clocks to each of the plurality of compression engines.

According to an embodiment, the decompression engine may be a given decompression engine of a plurality of decompression engines. Such an embodiment may also include the second clock signal coupled to the plurality of decompression engines.

In an embodiment, the second clock signal may be a given decompression clock signal of a plurality of decompression clock signals, and the decompression engine may be a given decompression engine of a plurality of decompression engines. Such an embodiment may further include at least one decompression clock signal of the plurality of decompression clock signals being coupled to at least one decompression engine of the plurality of decompression engines. Further, in such an embodiment, at least one switch may be configured to control a distribution of each respective clock signal from each of the plurality of decompression clocks to each of the plurality of decompression engines.

Another embodiment may include at least one controller coupled to the compression engine configured to control operation of the compression engine, and at least one controller coupled to the decompression engine configured to control operation of the decompression engine.

Another embodiment is directed toward a method for optimizing compression and decompression of data. The method may include receiving, at a compression engine, a first clock signal, the first clock signal having a first frequency. The method may include compressing the data via the compression engine, and regulating a speed of data compression by the compression engine via the first clock signal. Further, the method may include receiving, at a decompression engine a second clock signal, the second clock signal having a second frequency that is a different frequency than the first frequency. The method may include decompressing the data via the decompression engine, and regulating a speed of data decompression by the decompression engine via second clock signal. Further, the method may optimize at least one performance metric associated with the compression and decompression of data via the first frequency and the second frequency.

Another embodiment is directed toward a hardware description language (HDL) design structure encoded on a machine-readable data storage medium. The HDL design structure embodiment may include elements that when processed in a computer-aided design system generate a machine-executable representation of a semiconductor structure. Such a structure may include a compression engine for receiving a first clock signal, the first clock signal having a first frequency. Further, the compression engine may be configured to compress data, and the first clock signal may be used to regulate a speed of data compression by the compression engine. The HDL design structure embodiment may include a decompression engine for receiving a second clock signal, the second clock signal having a second frequency that is a different frequency than the first frequency. Further, the decompression engine may be configured to decompress data, and the second clock signal may be used to regulate a speed of data decompression by the decompression engine. In such an embodiment, the first frequency and the second frequency may be configured to optimize at least one performance metric associated with the compression and decompression of data.

It is noted that embodiments of the method, system, and hardware description language may be configured to implement any embodiments, or combination of embodiments, described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a workflow diagram of a legacy system for compression and decompression of data utilizing a single clock.

FIG. 2 is a workflow of a system for compression and decompression of data utilizing a dedicated clock for a plurality of compression engines and a dedicated clock for a plurality of decompression engines, according to an embodiment.

FIG. 3 is a flow diagram of a method for optimizing compression and decompression of data, according to an embodiment.

FIG. 4 is a workflow diagram of a system for optimizing compression and decompression of data, utilizing a plurality of compression clock signals and compression engines, utilizing a plurality of decompression clock signals and decompression engines, according to an embodiment.

### DETAILED DESCRIPTION

A description of example embodiments follows.

Data compression is the process of encoding information, wherein the encoding results in a data structure comprised of fewer data bits than the original piece of data, thereby allowing for a large amount of information to be stored on a smaller memory, relative to the size of the data being stored. The process of encoding (i.e. compressing, or deflating) the data takes both time and processing power, as data encoding can be a labor intensive process for a computer processor. To retrieve the compressed data from the memory where it has been stored and provide it to a user in a viewable format, the processor must then decode (i.e., decompress, or inflate) the data. While the process of decompressing the data likewise takes both time and processing power, decompressing the data may often take less time and less processing power than is required to compress the data in the first place. The time required to compress or decompress data is often referred to as latency, where a low latency refers to a faster compression / decompression time, and a high latency refers to a slower compression / decompression time.

The compression latency generally does not impact users, however, the decompression latency often creates a meaningful impact to users. For example, when a user or a process saves a data file to a memory, e.g., a data center, the speed at which the data file is compressed and saved is often of no consequence to the user or process as the user or process is likely finished using the data file. Therefore, no one is waiting for the compression task to be completed, and it can happen in the background. However, the speed at which the data file is decompressed as it is retrieved from the memory is often of great consequence to the user or process, as they are likely waiting to receive the data they have requested.

Hardware implementations of data compression and decompression algorithms introduce latency into the data pipeline. For storage applications, this latency is reasonably small. However, for memory expansion applications such as Compute Express Link (CXL) memory expanders, this latency is significant, as CXL memory expanders require large amounts of memory. In CXL memory expander applications it is often desirable to maximize storage capacity; therefore, lossless data compression such as “deflate” e.g., compression, are used. Since applications utilizing CXL memory expanders are often sensitive to load latency, measures must be taken in order to reduce additional latency for decompression. Historically, these measures often require significant power consumption.

The speed at which compression / decompression tasks take place is driven by a clock frequency. Generally, the faster the clock frequency the more tasks a processor may perform in a given amount of time, and the more power is consumed in the process. Likewise, the slower the clock frequency the less tasks a processor may perform in a given amount of time, and less power is consumed in the process.

One solution to reduce latency in compression / decompression algorithms is to increase the frequency of the shared clock for the compression / decompression engines. However, increasing the frequency of the shared clock causes the system to consume more power. While increasing the clock frequency and drawing more power may be beneficial for reducing latency associated with decompression tasks, since the clock is shared between the compression and decompression engines, more power is also drawn for the compression task without providing any perceivable benefit to the user or process. To remedy this, embodiments disclosed herein utilize a dedicated clock and clock signal for decompression tasks, and a dedicated clock and clock signal for compression tasks.

Embodiments utilize a dedicated clock (or clocks) for the compression engine (or engines) and a dedicated clock (or clocks) for the decompression engine (or engines), respectively, thereby enabling a user to independently optimize the clock speed for compression tasks and decompression tasks. In this way, decompression latency may be significantly reduced without altering compression latency, thereby preventing unnecessary power consumption from the compression engines.

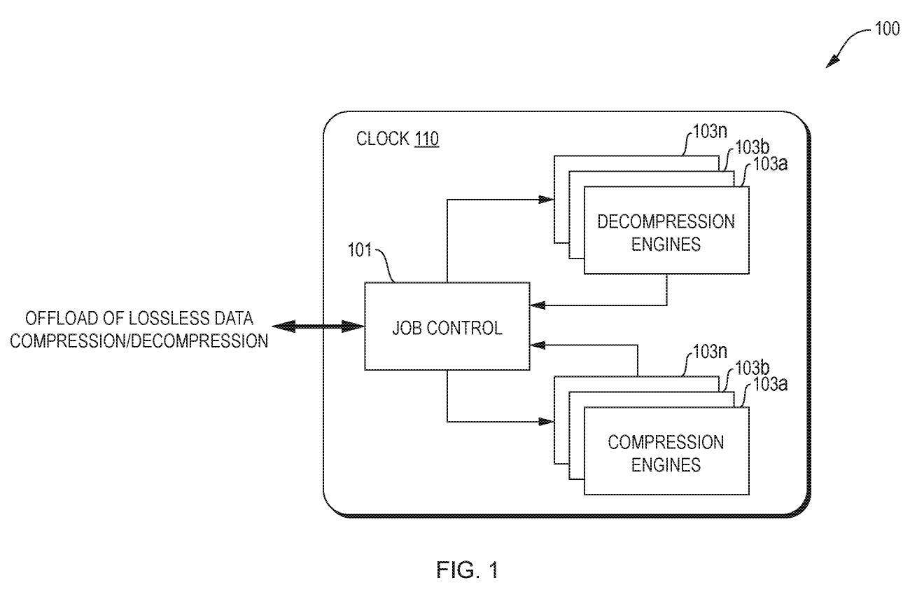

FIG. 1 is a workflow diagram of a legacy system 100 for compression and decompression of data utilizing a single clock 110. For example, in legacy system 100, a job controller 101 may be used to control operation of a plurality of decompression engines 102a-n and a plurality of compression engines 103a-n utilizing a single clock. The job controller 101 communicates with both the decompression engines 102a-n and compression engines 103a-n, and offloads lossless compressed or decompressed data. Since there is only one clock 110, each of the plurality of decompression engines 102a-n and compression engines 103a-n are operating at the same clock frequency. If a user or a program wishes to decrease the latency of the decompression engines 102a-n by increasing the clock 110 speed, then the latency of the compression engines 103a-n is also decreased. By fixing the compression engines 103a-n to operate at the frequency optimal for the decompression engines 102a-n, the legacy system 100 is inefficient because it consumes more power than is required for compression 103a-n tasks.

For example, the decompression of a 4 kilobyte (KB) block is a sequential process that may require on the order of 1000 clock cycles to complete. As previously stated, increasing the clock frequency of the decompression task reduces latency but consumes more power. For example, decompressing a 4 KB block with a clock speed of 2.4 giga-hertz (GHz) may take around 416 nanoseconds (ns), whereas decompressing a 4 KB block with a slower clock speed of 1.8 GHz may take around 555 ns. If, in the system 100, the clock 110 operates at 2.4 GHz, decompression latency will hit its target speed, but will burn unnecessary power for compression tasks. However, if, in the system 100, the clock 110 operates at 1.8 GHz, the latency for decompression may not achieve its target speed, which may not be acceptable by the user or process, and the power saved in compression is not desired.

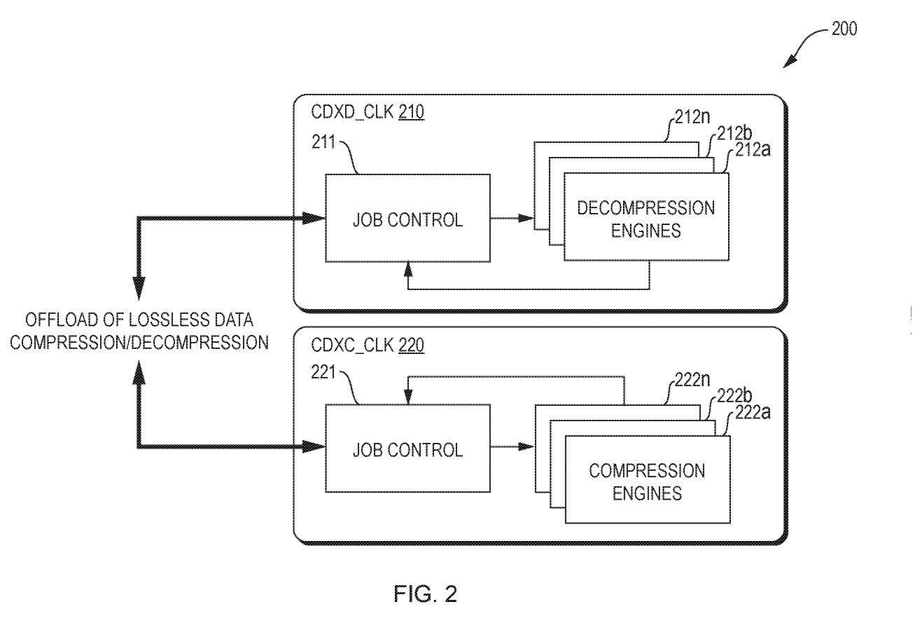

FIG. 2 is a workflow diagram of a system 200 for compression and decompression of data utilizing a dedicated clock 210 for the plurality of compression engines 212a-n and a dedicated clock 220 for the plurality of decompression engines 222a-n, according to an embodiment. For example, a job controller 211 may be used to control operation of a plurality of decompression engines 212a-n using a dedicated decompression clock 210 operating at a dedicated frequency. According to an embodiment, this frequency associated with decompression clock 210 may be optimized for decompression tasks. The decompression engines 212a-n communicate with the job controller 211 and offloads lossless decompressed data. Further, a second job controller 221 may be used to control operation of a plurality of compression engines 222a-n using a dedicated compression clock 220 operating at a dedicated frequency. The compression engines 222a-n communicate with the job controller 221 and offloads lossless compressed data. This novel arrangement with a dedicated clock 220 for data compression and a dedicated clock 210 for decompression allows the frequencies of each respective clock 210 and 220 to be optimized for their respective tasks, i.e., compression clock 220 may be configured at a frequency that is configured to optimize performance metrics required from compression engines 222a-n performing data compression tasks, such, for example, minimizing power consumption, and decompression clock 210 may be configured at a frequency that is configured to optimize performance metrics required from decompression engines 212a-n performing data decompression tasks, such as, for example, minimizing latency.

By utilizing these two dedicated clocks 210 and 220, embodiments may be able to, for example, run the decompression engine at 2.4 GHz clock speed and run the compression engine at 1.8 GHz clock speed. In this optimization, the latency for decompression is low, and the power consumption for compression is low.

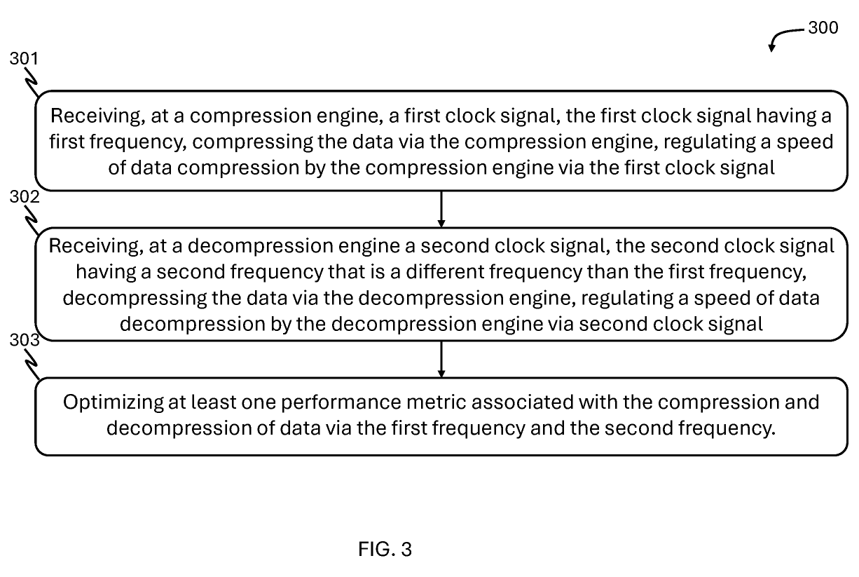

FIG. 3 is a flow diagram of a method 300 for optimizing compression and decompression of data, according to an embodiment. The method begins at step 301 by receiving, at a compression engine (e.g., compression engine 222a), a first clock signal (e.g. clock 220) having a first frequency (i.e., a given frequency unique to the first clock signal), compressing the data via the compression engine, and regulating a speed of data compression by the compression engine via the first clock signal. Method 300 continues at step 302 by receiving, at a decompression engine (e.g., decompression engine 212a) a second clock signal (e.g., clock 210) having a second frequency that is a different frequency than the first frequency (i.e., a given frequency unique to the second clock signal), decompressing the data via the decompression engine, and regulating a speed of data decompression by the decompression engine via the second clock signal. Thereafter, at step 303, the method 300 continues by optimizing at least one performance metric associated with the compression and decompression of data via the first frequency and the second frequency.

According to an embodiment, the at least one performance metric optimized at step 303 of method 300 may include, for example, latency (i.e., compression / decompression latency), power consumption, or any combination thereof.

Further, according to an embodiment of the method 300, the first frequency of the first clock signal received at step 301 may differ from the second frequency of the second clock signal received at step 302. For example, since it may be optimal for the decompression engines to have a latency lower than the compression engines, the second frequency of the second clock signal (e.g., the clock signal and frequency associated with the decompression engines) may be a higher frequency than the first frequency of the first clock signal (e.g., the clock signal and frequency associated with the compression engines).

The method of 300 may also include a memory. This memory may be, for example, a local memory or a data center. The method 300 may further include receiving at the memory, compressed data from the compression engine and transmitting the compressed data from the memory to the decompression engine. According to an embodiment, the memory may be a computer express link (CXL) memory expander.

According to an embodiment of the method 300, the first clock signal may be generated by a first programmable clock (e.g., clock 220) configured to generate a first programmed frequency, and the second clock signal may be generated by a second programmable clock (e.g., clock 210) configured to generate a second programmed frequency.

The compression engine may be a given compression engine of a plurality of compression engines (See, 222a-n). In such an embodiment, the first clock signal may be coupled to the plurality of compression engines.

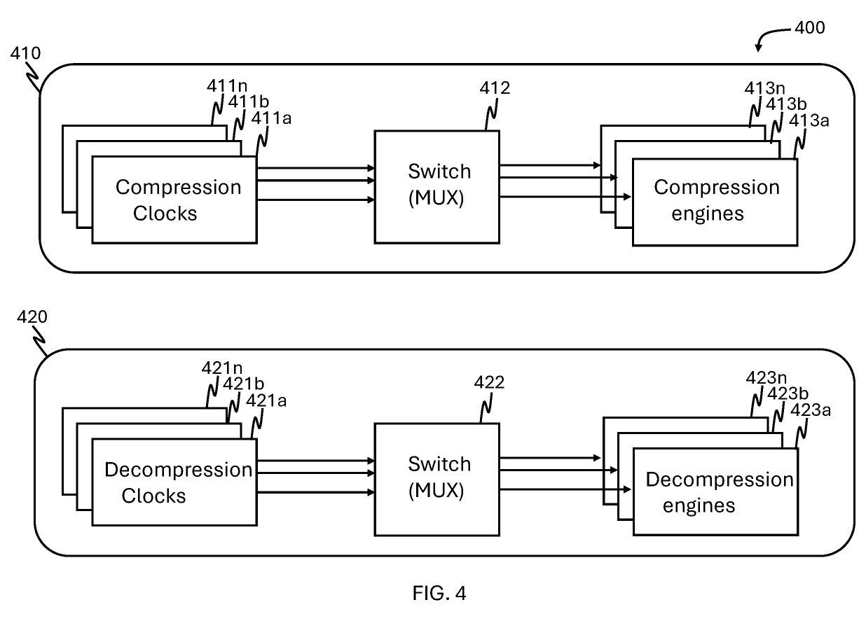

According to an embodiment of the method 300, the first clock signal may be a given compression clock signal of a plurality of compression clock signals and the compression engine may be a given compression engine of a plurality of compression engines. (See, FIG. 4, discussed hereinbelow) Further, at least one compression clock signal of the plurality of compression clock signals may be coupled to at least one compression engine of the plurality of compression engines. In such an embodiment, the method 300 may further include configuring at least one switch to control distribution of each clock signal from each of the plurality of compression clocks to each of the plurality of compression engines.

According to an embodiment of the method 300, the decompression engine may be a given decompression engine of a plurality of decompression engines (See, 212a-n). The method may further include coupling the second clock signal to the plurality of decompression engines.

According to an embodiment of the method 300, the second clock signal may be a given decompression clock signal of a plurality of decompression clock signals and the decompression engine may be a given decompression engine of a plurality of decompression engines. (See, FIG. 4, discussed hereinbelow) Further, at least one decompression clock signal of the plurality of decompression clock signals may be coupled to at least one decompression engine of the plurality of decompression engines. In such an embodiment, the method 300 may further include configuring at least one switch to control distribution of each clock signal from each of the plurality of decompression clocks to each of the plurality of decompression engines.

The method 300 may further include coupling at least one controller to the compression engine to control operation of the compression engine, and at least one controller coupled to the decompression engine configured to control operation of the decompression engine.

FIG. 4 is a workflow diagram of a system 400 for optimizing compression 410 and decompression 420 of data, according to an embodiment. In the system 400, the compression workflow 410 includes a plurality of compression clocks 411a-n, a switch 412 (e.g., a multiplexer (MUX) switch), and a plurality of compression engines 413a-n. According to an embodiment, each compression clock 411a-n may generate a respective clock signal and transmit their respective clock signals to the switch 412. The switch 412 may then distribute the plurality of clock signals to the plurality of compression engines 413a-n. In this way, embodiments may support a plurality of compression engines operating at respective frequencies suitable to optimize their respective compression tasks. Further, in the system 400, the decompression workflow 420 includes a plurality of compression clocks 421a-n, a switch 422 (e.g., MUX switch), and a plurality of decompression engines 423a-n. According to an embodiment, each decompression clock 421a-n may generate a respective clock signal and transmit their respective clock signals to the switch 422. The switch 422 may then distribute the plurality of clock signals to the plurality of compression engines 423a-n. In this way, embodiments may support a plurality of decompression engines operating at respective frequencies suitable to optimize their respective decompression tasks.

While example embodiments have been particularly shown and described, it will be understood by those skilled in the art that various changes in form and details may be made therein without departing from the scope of the embodiments encompassed by the appended claims.

What is claimed is:

1. A system for optimizing compression and decompression of data, the system comprising:
a compression engine receiving a first clock signal, the first clock signal having a first frequency, the compression engine configured to compress data, the first clock signal being used to regulate a speed of data compression by the compression engine;
a decompression engine receiving a second clock signal, the second clock signal having a second frequency, the decompression engine configured to decompress data, the second clock signal being used to regulate a speed of data decompression by the decompression engine; and
wherein the first frequency and the second frequency are different frequencies and are respectively configured to optimize at least one performance metric associated with the compression and decompression of data.

2. The system of claim 1, wherein the at least one performance metric comprises latency, power consumption, area, or any combination thereof.

3. The system of claim 1, wherein the second frequency is higher than the first frequency.

4. The system of claim 1, wherein the system further comprises a memory configured to receive compressed data from the compression engine and to transmit compressed data to the decompression engine.

5. The system of claim 4, wherein the memory is a computer express link (CXL) memory expander.

6. The system of claim 1, wherein the first clock signal is generated by a first programmable clock configured to generate a first programmed frequency, and the second clock signal is generated by a second programmable clock configured to generate a second programmed frequency.

7. The system of claim 1, wherein the compression engine is a given compression engine of a plurality of compression engines, the system further comprising the first clock signal coupled to the plurality of compression engines.

8. The system of claim 1, wherein the first clock signal is a given compression clock signal of a plurality of compression clock signals and the compression engine is a given compression engine of a plurality of compression engines, the system further comprising at least one compression clock signal of the plurality of compression clock signals coupled to at least one compression engine of the plurality of compression engines.

9. The system of claim 8, further comprising at least one switch configured to control a distribution of each clock signal from each of the plurality of compression clocks to each of the plurality of compression engines.

10. The system of claim 1, wherein the decompression engine is a given decompression engine of a plurality of decompression engines, the system further comprising the second clock signal coupled to the plurality of decompression engines.

11. The system of claim 1, wherein the second clock signal is a given decompression clock signal of a plurality of decompression clock signals and the decompression engine is a given decompression engine of a plurality of decompression engines, the system further comprising at least one decompression clock signal of the plurality of decompression clock signals coupled to at least one decompression engine of the plurality of decompression engines.

12. The system of claim 11, further comprising at least one switch configured to control a distribution of each respective clock signal from each of the plurality of decompression clocks to each of the plurality of decompression engines.

13. The system of claim 1, further comprising
at least one controller coupled to the compression engine configured to control operation of the compression engine; and
at least one controller coupled to the decompression engine configured to control operation of the decompression engine.

14. A method for optimizing compression and decompression of data, the method comprising:
receiving, at a compression engine, a first clock signal, the first clock signal having a first frequency, compressing the data via the compression engine, regulating a speed of data compression by the compression engine via the first clock signal;
receiving, at a decompression engine a second clock signal, the second clock signal having a second frequency that is a different frequency than the first frequency, decompressing the data via the decompression engine, regulating a speed of data decompression by the decompression engine via second clock signal; and
optimizing at least one performance metric associated with the compression and decompression of data via the first frequency and the second frequency.

15. The method of claim 14, further comprising receiving, at a memory, compressed data from the compression engine, and transmitting compressed data from the memory to the decompression engine.

16. The method of claim 14, further comprising generating the first clock signal by a first programmable clock configured to generate a first programmed frequency, and generating the second clock signal by a second programmable clock configured to generate a second programmed frequency.

17. The method of claim 14, wherein the first clock signal is a given compression clock signal of a plurality of compression clock signals and the compression engine is a given compression engine of a plurality of compression engines, the method further comprising coupling at least one compression clock signal of the plurality of compression clock signals to at least one compression engine of the plurality of compression engines.

18. The method of claim 14, wherein the second clock signal is a given decompression clock signal of a plurality of decompression clock signals and the decompression engine is a given decompression engine of a plurality of decompression engines, the method further comprising coupling at least one decompression clock signal of the plurality of decompression clock signals to at least one decompression engine of the plurality of decompression engines.

19. A hardware description language (HDL) design structure encoded on a machine-readable data storage medium, the HDL design structure comprising elements that when processed in a computer-aided design system generates a machine-executable representation of a semiconductor structure comprising:
a compression engine receiving a first clock signal, the first clock signal having a first frequency, the compression engine configured to compress data, the first clock signal being used to regulate a speed of data compression by the compression engine;
a decompression engine receiving a second clock signal, the second clock signal having a second frequency that is a different frequency than the first frequency, the decompression engine configured to decompress data, the second clock signal being used to regulate a speed of data decompression by the decompression engine; and
wherein the first frequency and the second frequency are configured to optimize at least one performance metric associated with the compression and decompression of data.

20. The HDL design structure of claim 19, further comprising elements that when processed in a computer-aided design system generates a machine-executable representation of a semiconductor structure comprising a memory configured to receive compressed data from the compression engine and configured to transmit compressed data to the decompression engine.
